(19) United States
(12) Patent Application Publication
(10) Pub. No.: US 2004/0177489 A1
(43) Pub. Date: Sep. 16, 2004

(54) Method and machine for the production of reinforcement and dowel side frames for concrete reinforcement from wire or rod or other material of prismatic cross section

(76) Inventor: Antonios Anagnostopoulos, Athens (GR)

Correspondence Address: Antonios Anagnostopoulos, 18 Ionos Street, Amaroussio Attikis, 15126, GR

(21) Appl. No.: 10/467,933

(22) PCT Filed: Dec. 27, 2001
(86) PCT No.: PCT/GR01/00050

(30) Foreign Application Priority Data
Feb. 22, 2001 (GR) 20010100096

(51) Int. Cl. B23P 25/00; B23P 17/00; B21K 23/00

(52) U.S. Cl. 29/527.1; 29/897.312; 29/417; 29/425; 29/34 D

(57) ABSTRACT

According to the method, the transversal wire or rebar to be formed (1) and the longitudinal wires or rebars or other material of prismatic cross section (2), (3) are fed to the main forming and welding machine subsystem, in a stepwise manner, at the appropriate distance each time, through a driving mechanism (22-30). At this location, the transversal wire (1) is cut and then formed upon the action of a press (36). Welding of the formed transversal frame with one of the two longitudinal wires is performed while the formed transversal wire is still restrained by the action of the press (38) at the formation location. Welding with the second longitudinal wire is performed at the next production step, simultaneously with the welding of the next transversal frame with the first longitudinal wire, at the formation location. After the welding action, the transversal frame is released by the press and the forming tools (37-39), and the next production step is initiated. The product is made in a continuous shape and is cut at the proper lengths, by a cutter (45).

The present invention refers to a method and a machine for the production of reinforcement and Dowel side frames for concrete, from wire or rod or other material of prismatic cross section.

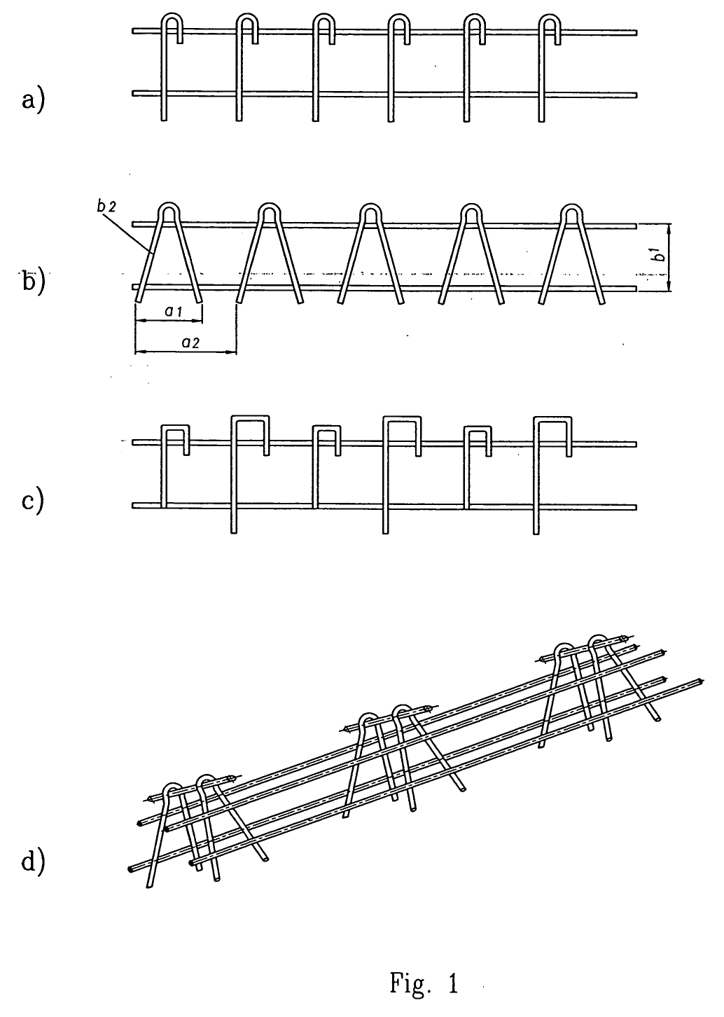

The products that are delivered by the machine, according to the present invention, are presented in FIG. 1. The products are characterized by two parallel wire rods and by appropriately formed wire frames, which are welded transversally on specific points on the two parallel wires, in order to create a uniform and rigid at one direction side frame (FIG. 1). The transversal wire frames may maintain the same geometry (FIG. 1a, 1b) or may vary, by alternating frames of two different geometries (FIG. 1c). The product is characterized by the distance of the two longitudinal wires (b1), by the step of the transversal frame (a1), by the distance of two consecutive transversal frames, measured on the points where their sides meet the longitudinal wires (a2), and the lengths of the transversal wire sides (b2). In the case of alternating transversal frames of two different geometries, the product is characterized further by the proportion of wire length on each side of the transversal frame with respect to the formation axis (b3).

The referenced product is used as reinforcement for concrete as well as in the composition of beams, columns and other construction made of reinforced concrete (FIG. 1d). Furthermore, it is used in the construction of buildings, roads and bridges, as well as in support beams for the manufacturing of metal constructions and metal shelters.

The referenced product is manufactured mainly semi-automatically. The transversal parts of the product are manufactured by a bending machine or by a press. The already formed pieces are transferred and placed on the longitudinal wires at specific locations, where they are welded either through electrodes (resistance welding) or through soldering. The disadvantages of the semi-automated manufacturing mode are the difficulty in maintaining the proper product geometry, the not-very consistent welding quality, and the high production cost.

The automated manufacturing is achieved with the following two methods. In the first method, the transversal wire frame is formed at an automatic bending machine and then it is transferred, through a robotic system, at the proper location, where it is welded with electrodes (resistance welding). In the second method, the transversal frame is manufactured by a press, and then, through a transfer mechanism, it is placed at the proper location, where it is welded with resistance welding.

The transfer mechanism of the already formed transversal frame constitutes the main disadvantage of the automated production methods, since the transfer mechanism makes the overall machine operation very complicated and expensive. Furthermore, the wire undergoes elastic deformation (recuperation), resulting in changes in the final product geometry and various inaccuracies during the transverse frame transfer.

The purpose of the present invention is the presentation of a method, which will overcome all the disadvantages of the existing methods and machines and which will lead to the manufacture of a machine, which will allow the fully automated manufacturing of the product, at a consistently high quality, and with flexibility in the manufacturing of a variety of products, i.e. leading to faster and simpler production of higher-quality products.

The aim of this invention is to supply a machine, which automates the production of (Dowel-type) side frames for concrete reinforcement, maximizes the machine flexibility and minimizes time for the machine adjustments (down time), produces excellent-quality product, where at the same time, it maintains simple design, reliable operation, user friendliness and high product capacity.

The present invention supplies a method for the manufacturing of Dowel-type reinforcment (FIG. 1) of various geometries, made of wire or rebar, tube or prismatic beam of arbitrary cross section, where the transversal frames of the reinforcement can be either of constant geometry or consisting of two different alternating geometrical shapes, and where the distance between each transversal frame can be constant or it may vary.

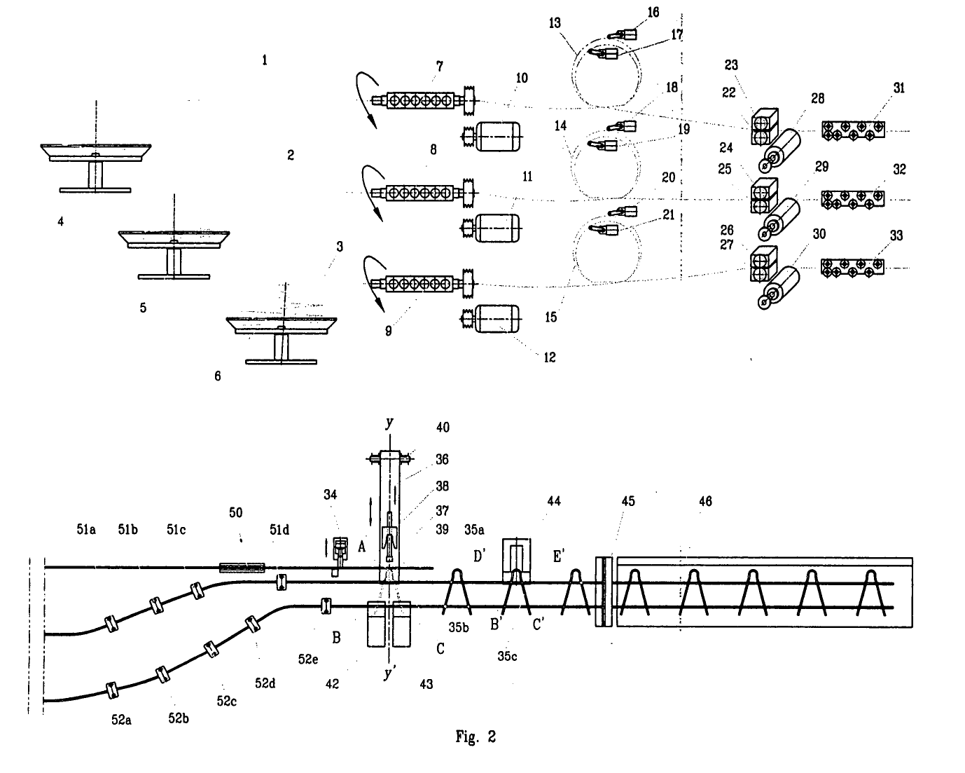

Three pay-off stations (4), (5) and (6) feed the wires (1), (2) and (3) (FIG. 2) into the machine. The three wires are straightened at three straightening devices (7), (8) and (9), which are driven by three motors (10), (11) and (12) respectively, and then they are forwarded to the wire buffers (13); (14) and (15) respectively. The quantity of the wire stored in each buffer is controlled by two terminal switches for each wire, which determine the minimum and maximum wire quantity stored in each buffer, and which control the start and stop operation of the motors (10), (11) and (12) respectively.

The wires (1), (2) and (3) are fed to the main transversal wire-formation mechanism through pairs of feeding rollers (22) and (23), (24) and (25), (26) and (27), driven by the motors (28), (29) and (30) respectively, after they are straightened again at the devices (31), (32) and (33), so that the slight deformation that they underwent in the buffers is eliminated. During feeding of the wires to the main mechanism, wire (1) is maintained fixed on a straight line, whereas wires (2) and (3) converge through guides (51a), (51b) etc. and (52a) to the appropriate distances required for each specific product, so that they can undergo the appropriate formations from the respective mechanisms, in the process of manufacturing the final product. The convergence of wires (2) and (3) is obtained at a suitable length, so that wires (2) and (3) do not undergo plastic deformation.

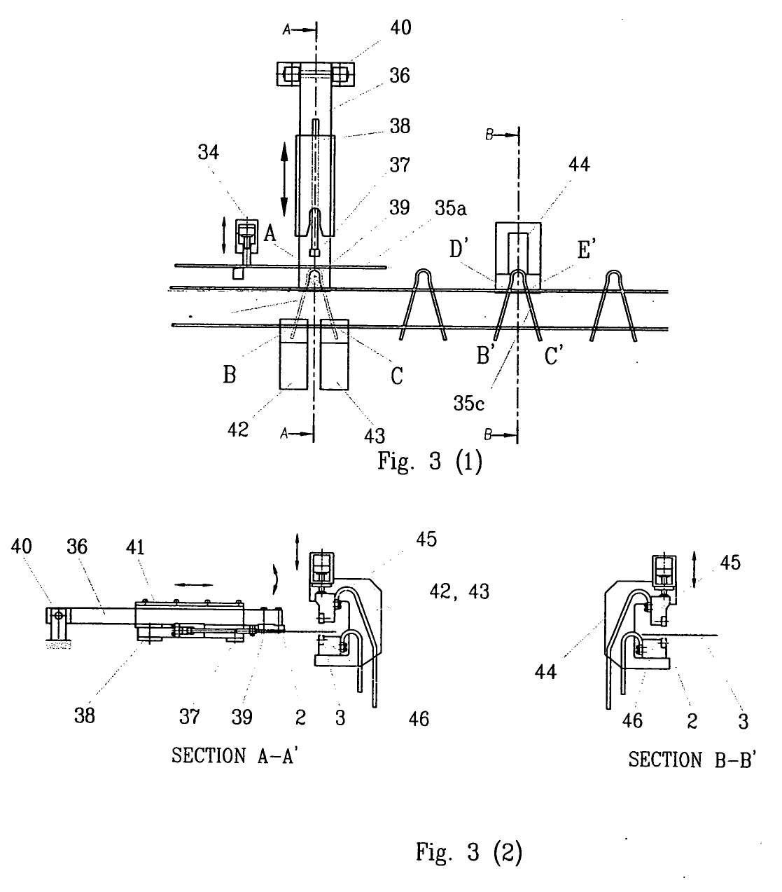

According to the present method (FIGS. 3.1, 3.2), two formation tools (38) and (39) and one restrainer (37) are utilized for the formation of the transversal wires, one wire cutter (34) is utilized for cutting of the transversal wire at the proper length, and three welding devices (42), (43) and (44) are utilized for the welding of the formed transversal wire pieces with the longitudinal wires (2) and (3). The wire formation tool (39) is nearly in contact with the wire to be formed (35a), whereas the formation tool (38) moves perpendicularly to the wire to be formed (35a), so that with the aim of tool (39) it provides the required formation. The restrainer of the wire (35a) moves perpendicularly to the wire to be formed (35a), it presses it on tool (39), and holds it during the cutting and formation process. The forming tools (38) and (39) and the restrainer (37) are able to move perpendicularly to the plane defined by the formed wires, where all cutting and forming processes of the transversal frames occur. Through this movement, the formation tools along with the restrainer can move towards the formation plane, so that the wire (35a) is formed to the shape (35b), and consequently, they move away from the formation plane and the formed wire (35b), so that the formed transversal frame can be advanced. In FIG. 3, and for the sake of better understanding of the present invention, in one implementation, the moving formation tools and the restrainer are supported on a beam, free at one edge (the one near the formation tools) and simply supported and been able to rotate at the other (far) edge.

The welding devices (42) and (43) are positioned one at each side of the axis of formation of the tools (38) and (39) and at the locations where the formed wire (35b) intersects the longitudinal wire (3), whereas the welding device (44) is positioned on the transversal wire (2), at a distance from the formation tools axis, equal to an integral multiple of the product step.

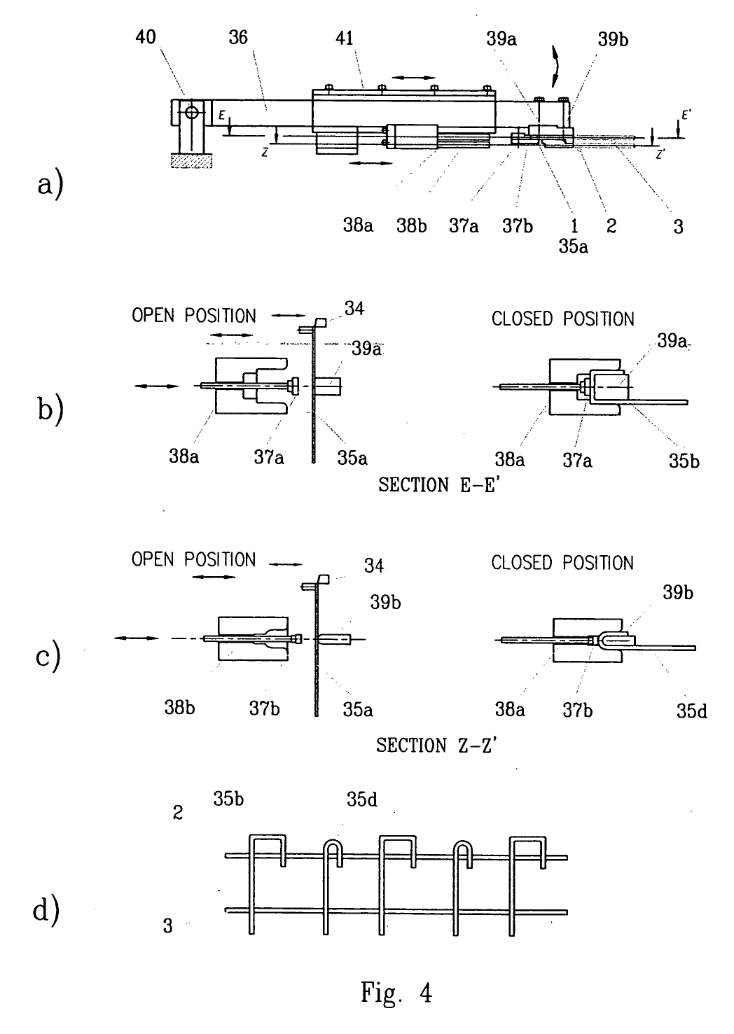

The process for completion of one product step is the following (FIGS. 3, 4):

Wires (2) and (3) are fed into the formation mechanism at a length equal to one step of the complete final product, and wire (1) is fed at a length equal to the initial length of each transversal piece before formation occurs. The cutter is placed at the appropriate location so that it can cut off the right length of the transversal wire to be formed.

Wire (1) is held firmly on the formulation tool (39) by the restrainer (37) and it is cut off at the appropriate length by the cutter (34). The forming tool (38) moves towards the tool (39) and deforms the wire (35a) bringing it to the shape (35b). During the formation process, the two ends of the formed wire (35b) are transferred to points B and C (FIGS. 3.1, 3.2), where the formed wire (35b) is welded with the longitudinal wire (3) at the welding devices (42) and (43) either through electrodes (resistance welding) or alternately through soldering, while the formed wire (35b) is firmly held by the restrainer (37) and is entrapped by both formation tools (38) and (39).

Following the above, restraining (37) is released and the tool (38) moves away from the tool (39), so that the formed transversal wire, which is welded on the longitudinal wire (3), is no longer restrained. The formation tools (38), (39) and (37) move away from the formed transversal wire towards a direction perpendicular to the formation plane, so that the formed transversal wire is released and can be advanced away from the formation mechanism.

After the formed wire frame (35b) is released from the formation tools it advances by one product step, carried by the wires (2) and (3), which advance at a length equal to one product step. At the same time, wire (1) advances at a length equal to the initial length of each transversal piece. The formed wire (35b) moves to the location (35c), where it is welded at points D and E, by the welding device (44). Welding at points D and E takes place simultaneously with the formation of the next transversal wire frame (35b) on the formation mechanism by the tools (38) and (39).

The step-by-step manufactured product is transferred to a storage unit (46), through cutter (45). When the required length of product is achieved, the cutter (45) is activated, and the product is delivered to the storage unit (46).

The transversal formed wires may all be the sane, as described until now, or they can consist of two alternating geometrical shapes, as presented in the example of FIG. 4d.

In this case, each transversal formed wire is produced by its own pair of forming tools and restrainer. The transversal wire frame (35b) is produced by the tools (38a, 39a) and the restrainer (37a) (FIG. 4b), whereas the transversal wire frame (35d) by the tools (38b, 39b) and the restrainer (37b). The forming tools and restrainers are properly placed one under the other (FIG. 4a). The height (thickness) of the tools corresponds to the diameter of the wire to be formed.

The location of the wire to be formed (1) is maintained fixed in space, and able to move on a straight line. The forming tools and the restrainer can move at a direction normal to the formation plane EE′ (FIG. 4a), so that the proper tools for each transversal wire frame are transferred to the formation plane EE′. In one implementation of the method (FIG. 4), the transfer of each set of formation tools and restrainer is implemented by rotation of the tools supporting frame about a point far from the wire formation location. Thus, by rotating the beam (36) about axis (40), the respective forming tools and restrainer, which are shown at the cross sections EE′ and ZZ′ (FIGS. 4b, 4c) respectively, are transferred to the formation plane EE′.

The welding part is implemented in the same manner as in the case of transversal wires of only one geometrical shape, at the welding devices (42), (43) and (44), which are placed at the appropriate locations with respect to the formation axis.

In the case where two different shapes of transversal frames are formed, the cutter (34) is placed on a guide, and is transferred to the appropriate each time location for each transversal wire.

In the case where the welding devices (42), (43) and (44) must act at different locations with respect to the formation axis each time, they are supported on a transfer mechanism, which moves them at the appropriate location for the welding action, each time.

The ends of the transversal wire frames may be protruding beyond the second longitudinal wire, as shown in FIGS. 1a, 1b and in half of the transversal frames of FIG. 1c or they may not be protruding beyond the second wire as in half of the transversal frames of FIG. 1c. Production of this arrangement is possible because the transversal frame is welded while it is restrained on the formation position.

A characteristic of the present method is the production of the transversal frame with the aim of a forming mould.

A characteristic of the present method is the welding of the formed transversal wire with one of the two longitudinal wires at the formation location, without the need for a mechanism for the transfer of the formed transversal wire from its formation location to some other location for welding.

A characteristic of the present method is the capability to produce a variety of shapes of transversal wire frames, which are welded to one longitudinal wire at the formation location.

A characteristic of the present method is the capability for the transversal wires not to be protruding from the second longitudinal wire (FIG. 1c).

A characteristic of the present method is the welding of the formed transversal wire with the second longitudinal wire at a distance equal to a multiple of the product step, and simultaneously with the next transversal wire formation.

A characteristic of the present method is the simple and quick change of the forming tools, therefore of the shape of the produced transversal wires.

A characteristic of the present method is the easy change of the product step, since it only relates to the change of the length of the advancement of the wires and the location of the welding devices.

A characteristic of the present method is the particularly high quality of the final product, since the welding of the formed transversal wires occurs simultaneously with their formation, thus preserving their shape without allowing deformations due to elastic recuperation.

A characteristic of the present method is the simple and distributed procedures, which lead to a very simple implementation.

More details about the method and the machine, according to the present invention, will be understood, after the description of the following implementation of the machine. The machine is described in the attached schemes, in the sense of a non-restrictive example.

FIG. 1 presents schematically the machine products.

FIG. 2 presents the main concept of the present method (layout).

FIG. 3 details the main formation and welding mechanisms.

FIG. 4 illustrates the main formation and welding mechanisms for two different shapes of transversal formed wires.

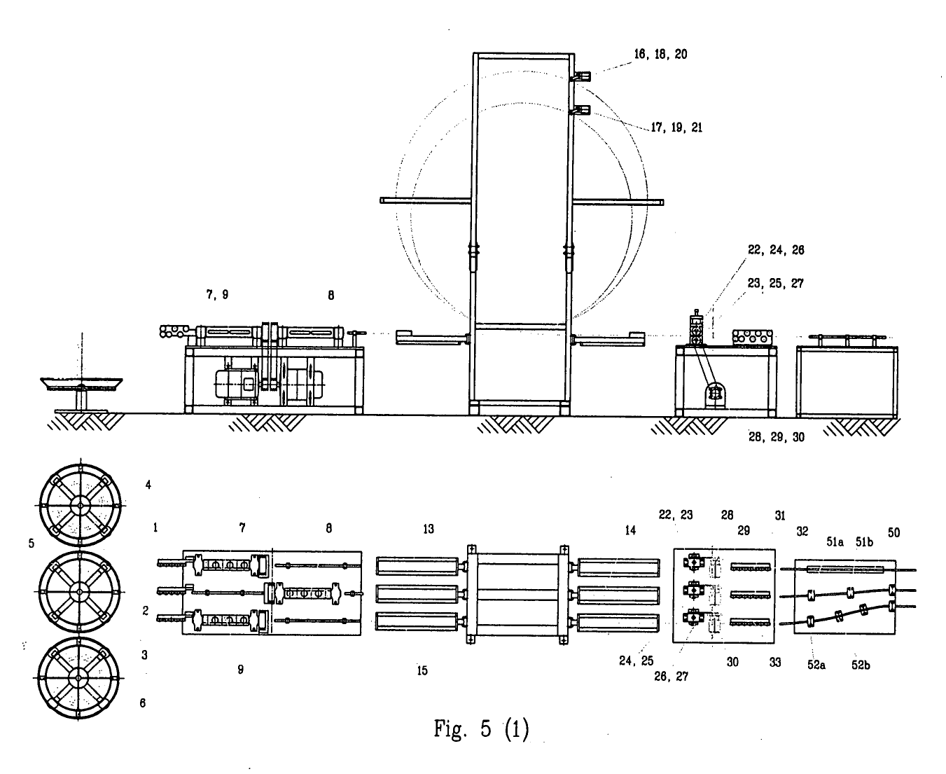

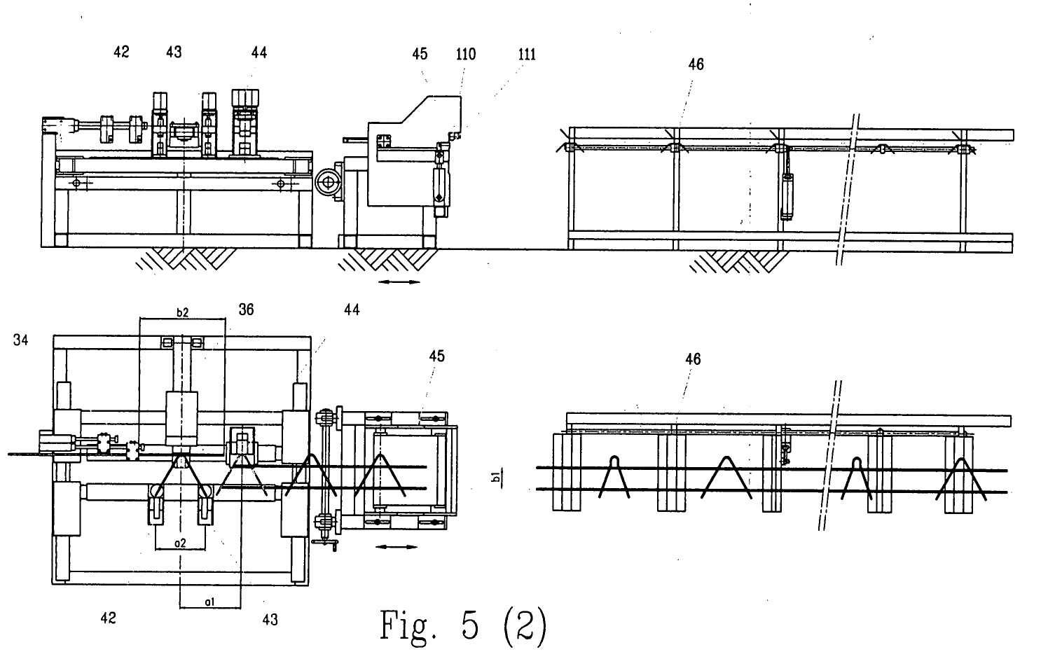

FIG. 5 (1), 5(2) shows the general machine layout.

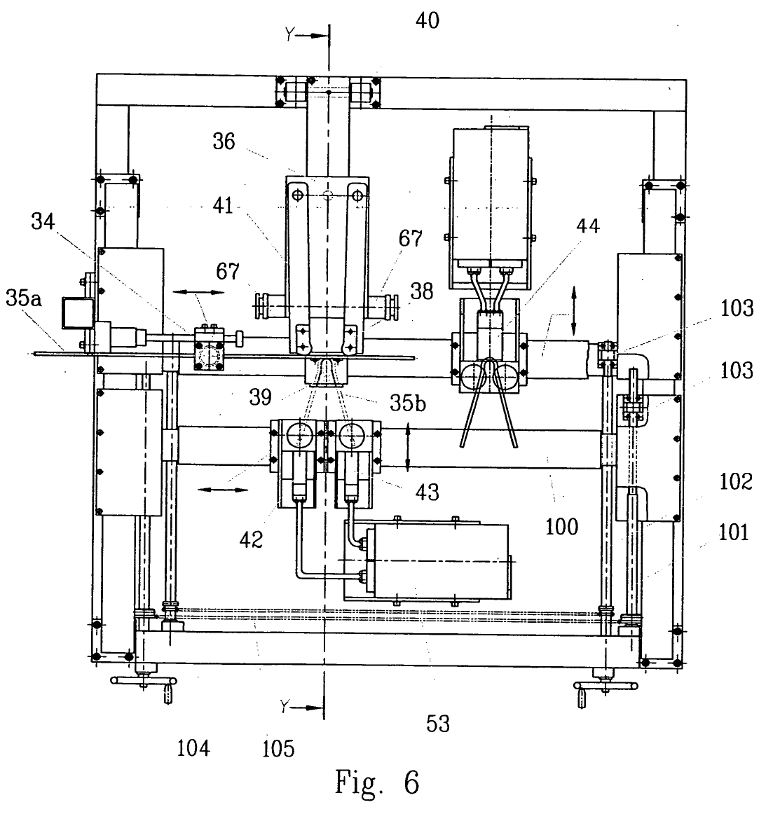

FIG. 6 shows a top view of the formation and welding mechanisms.

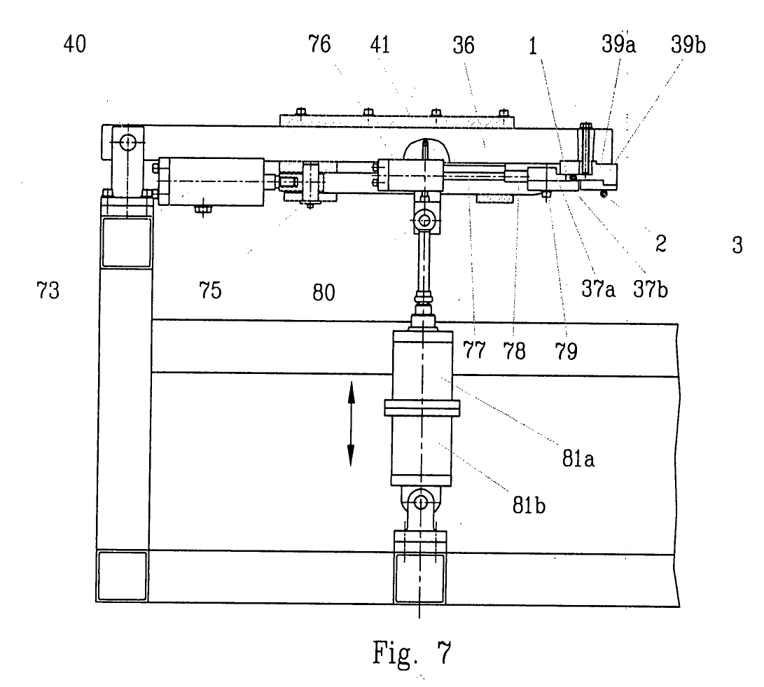

FIG. 7 shows a cross section of a side view (along YY′) of the formation and welding mechanisms.

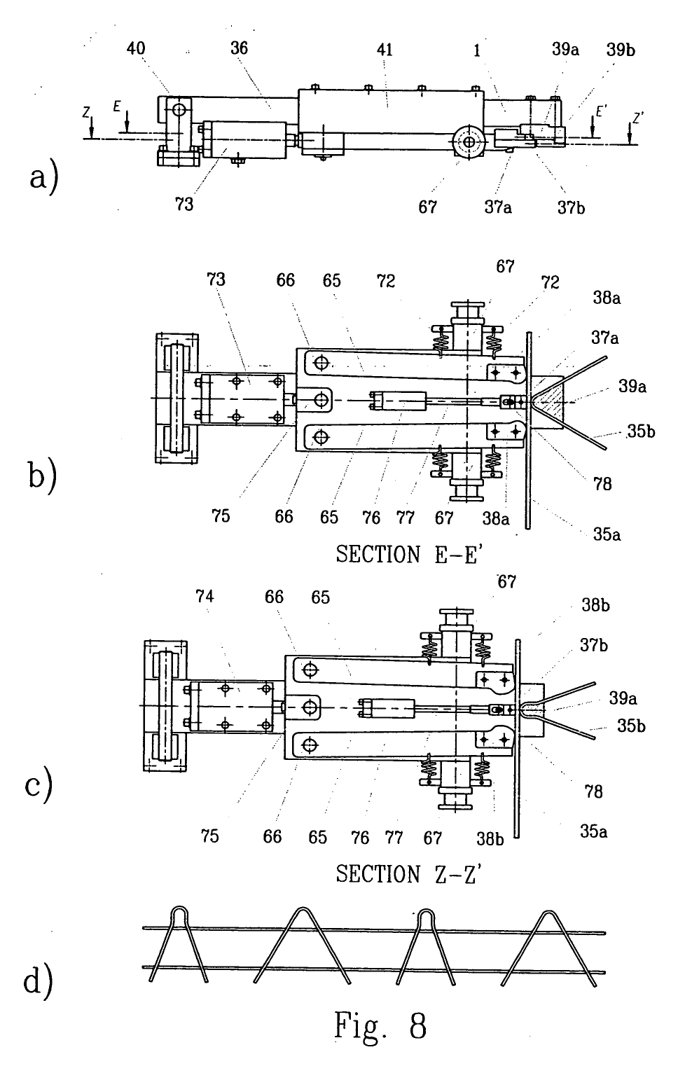

FIG. 8 details the restrainer and the forming tools.

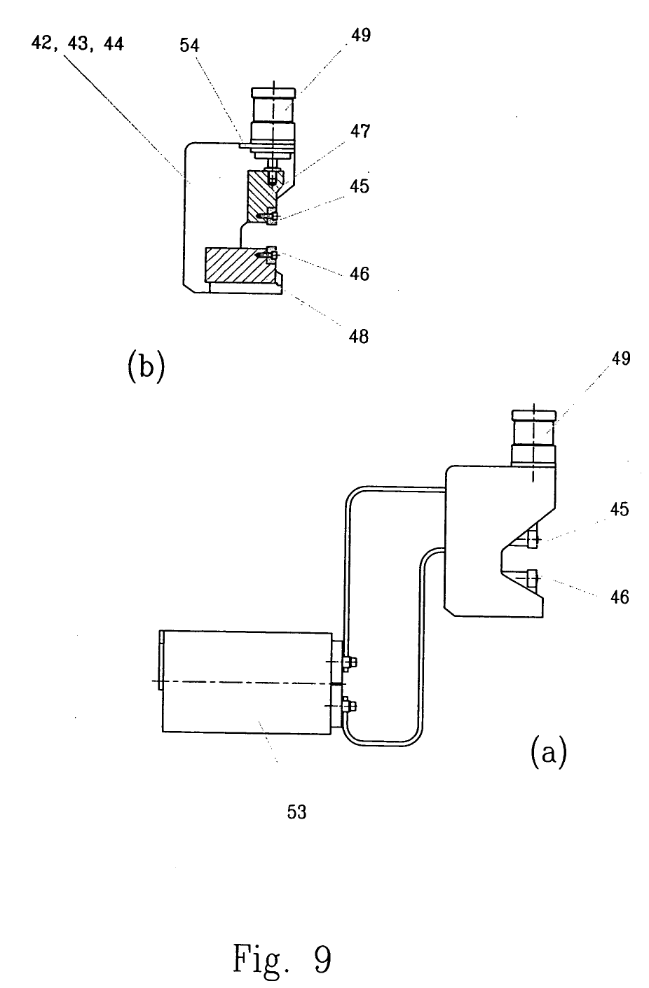

FIG. 9 details the welding devices.

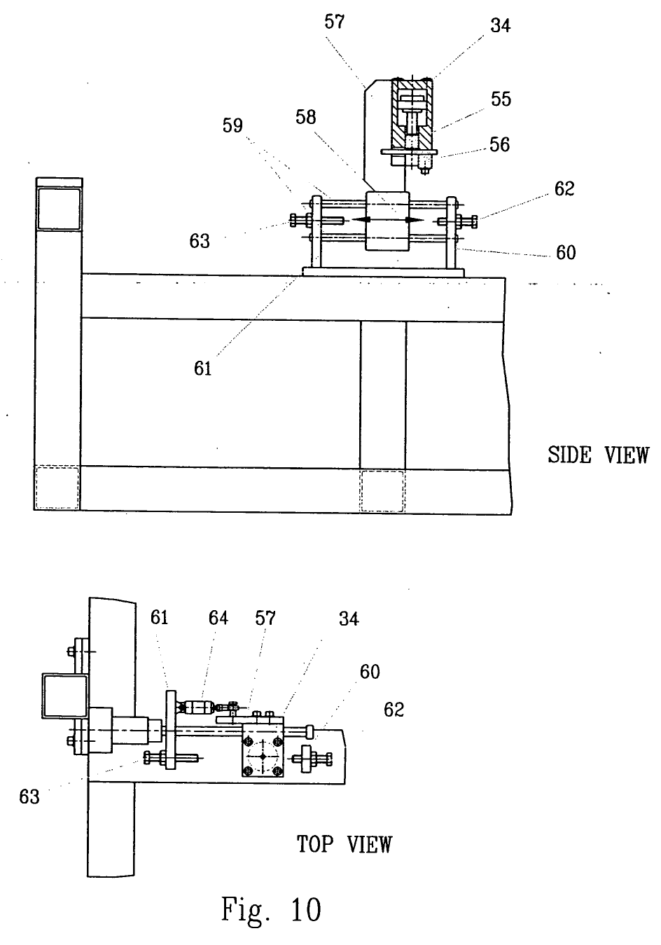

FIG. 10 shows a side and a top view of the cutter and its supporting frame.

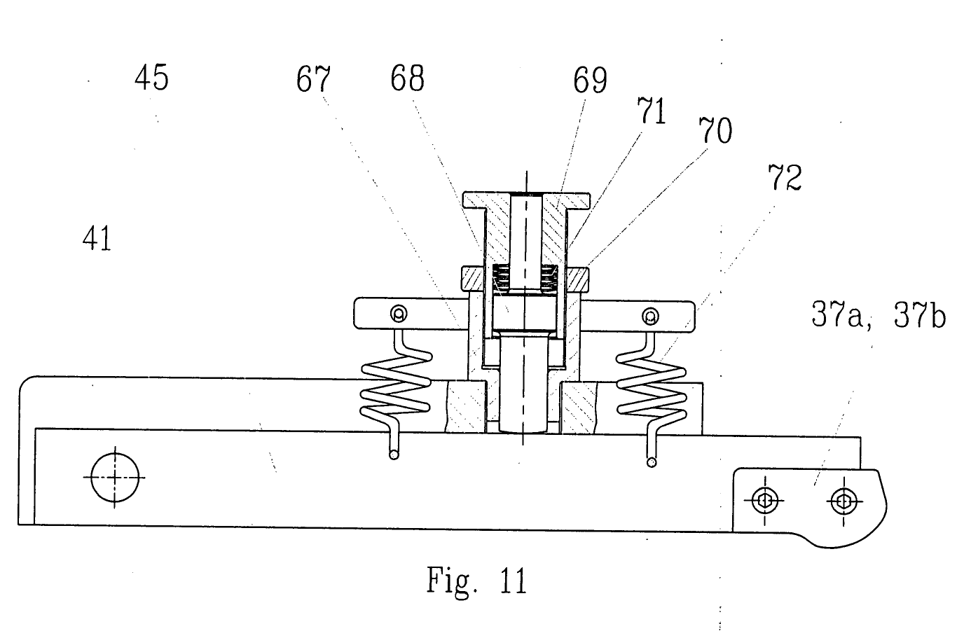

FIG. 11 illustrates the spring mechanisms of the moving forming tool.

A particular implementation of the formation method is presented in FIG. 5 (FIGS. 5.1, 5.2). For the sake of the example and without restricting the range of the method applications, the material to be formed (1) and the materials of the longitudinal wires (2) and (3) are considered wires of cylindrical cross section.

The general layout of the machine is shown in FIGS. 5(1) and 5(2), at a top view and a side view, where FIG. 5.2 is the continuation of FIG. 5.1. The machine consists of the main forming mechanism, which is the main subject of the present invention, the supply to the machine and the collection of the final product.

Following the course of the material, the machine is composed from the following subsystems.

Wires (1), (2) and (3) are uncoiled by the pay-off stations (4), (5) and (6) respectively, are straightened on the straightening units (7), (8) and (9) respectively, which on this particular implementation operate with a straightening rotor, and are guided to the wire storage units (buffers) (13), (14) and (15) respectively. The quantity of stored wire in the buffer is controlled by two terminal switches per wire, e.g. (16) and (17) for wire (1), where the switch (16) is activated when the buffer is full and sends a signal to the motor (10) driving the straightening unit (7) to stop feeding the buffer, whereas when the buffer is emptied, the switch (17) is activated and sends a signal to the motor (10) of the straightening unit (7), so that the motor starts to store wire in the buffer again. This operation takes place independently for each one of the three wire storage units.

Wires (1), (2) and (3) are pulled easily and with very small resistance from the buffer units, by the pairs of rollers (22) and (23), (24) and (25), (26) and (27) respectively, which are driven by the motors (28), (29) and (30) respectively, and are guided to the single-plane straightening units (31), (32) and (33) respectively, so that any small plastic deformations, acquired in the buffers be eliminated.

At the next step, the wires are guided towards the main forming mechanism, after having converged to the proper distances for the production of each particular product. Wire (1) remains on a straight line and is not relocated for different products. Convergence of the wires (2) and (3) is facilitated by guides (51a), (51b) etc. and (52a), (52b) etc. respectively, placed on a table, which guide the wires to the proper distance from the fixed longitudinal wire. The guidance length of the wires until convergence is obtained is sufficiently long, so that no plastic deformation is taking place during forced guiding of the wires.

At the next step, the wires are inserted into the main forming and welding mechanism, which is in detail presented in FIGS. 6, 7, 8, 9, 10 and 11. For the sake of the example, the forming and welding subsystem is implemented with two pairs of forming tools for forming of two different transversal shapes, as presented in FIG. 8(d). The forming and welding subsystem consists of the main forming mechanism (36), which carries the forming tools (38a, 38b), (39a, 39b) and the restraining tools (37a, 37b), the welding devices (42) and (43) for welding of the formed transversal wire with the longitudinal wire (2), the welding device (44) for welding of the formed transversal wire with the longitudinal wire (3), the cutter (34) and the cutters' transfer mechanism, the mechanisms for the transfer of the welding devices to the appropriate locations for production of a particular product each time, and the metal frame of the subsystem.

The location of axis YY′ of the forming mechanism (FIG. 6), is fixed on the mechanism, just like the straight line defined by wire (1), hence the point on wire (1), where forming will take place is also fixed. The longitudinal wires (2) and (3) are guided at the proper distances from the wire (1), as defined from the product's geometry. The welding devices (42) and (43) are placed at the intersections of the formed transversal wire (35b) with the longitudinal wire (3). The welding device (44) is placed at a distance from the axis of the forming mechanism equal to a multiple of the step of the product, and on the longitudinal wire (2). Finally the cutter (34) is aligned with the wire (1) feeding, and at the appropriate distance from the axis of the forming mechanism, depending on the length and shape of the transversal wire.

The forming tools (39a) and (39b) (FIGS. 6, 7, 8) are placed on a projectile beam (36), where they are mounted with screws. The beam (36) is rotated about axis (40), with the aim of pistons (81a) and (81b), which are supported through a joint (FIG. 7) on the frame of the machine and on the beam (36). When both pistons (81a) and (82b) are activated, the forming tools are located above the forming plane of the transversal wire, when only piston (81b) is activated, the forming tools (39b) and (38b) are placed on the forming plane, and when both pistons are deactivated then the tools (39a) and (38a) are on the forming plane.

The forming tools (38a) and (38b) (FIG. 8) are mounted on two metal blades (65) and are supported on a moving frame (41), which can move relatively to the beam-guide (36), through two pins (66). The moving frame (41) and consequently the forming tools (37a) and (37b) can move through the action of a hydraulic piston (73), which is supported on the beam (36). The forming tools (38a) and (38b) remain at a specific position with respect to the tools (39a) and (39b), through a mechanism with disk-type springs (67) and springs (72), which will be presented in detail below.

The restrainer (37a) and (37b) is mounted on a supporting base (78), which can move upon activation of the hydraulic piston (76), which is supported on the beam (36). To avoid unwanted torsional stresses, the restrainer is guided by the bolt pin (79), which is also supported on beam (36).

The welding devices (42), (43) and (44) (FIG. 9) are identical and consist of the welding copper electrodes (45) and (46), their respective supporting bases made of electrolytic copper (47) and (48), a pneumatic piston (49), the metal frame (54), and the insulation of the frame and the remaining devices with insulating material i.e. panite. Both electrodes are supplied with electrical current from a welding transformer, which is connected with flexible copper cables. The welding devices perform resistance welding, i.e. they press the wires to be welded together, transmit strong, low-voltage current, thus inducing local melting of the material and consequently welding.

The cutter (34) (FIG. 10) at a side view and top view, consists of two steel blades, one fixed (56) and one moving (55), where the moving blade is driven by a hydraulic piston.

The cutter (34) is supported on a moving frame (58) through a blade (57). The moving frame (58) and consequently the cutter, can move through a pneumatic piston (64) between two positions, which are determined by two mechanically regulated stops (62) and (63). The cutter's support and transfer mechanism is mounted on the frame of the machine with the blades (61).

The location of the forming tool (38a) and (38b) with respect to the forming tool (39a) and (39b) is determined by the pin (68) (FIG. 11), which is pushed by the hard disc-type springs (71) and by the regulated mechanical stop (72). The force exerted by the pin (68) is determined by the pre-contraction of the springs (71), which is regulated by the bolt (69), and is secured by the nut (70).

The welding devices (42); (43) and (44) can move at the appropriate locations through pin-bolts and chains. For example, the welding device (42) is driven by the bolt (101), the chain (105) and the steering wheel (volant) (104).

The machine operates in the following way:

Initially, the appropriate forming tools, the cutter and the welding devices are placed at the appropriate positions.

The beam (36) moves upon deactivation of pistons (81a) and (81b) and transfers the forming tools (39a) and (38b) at the horizontal level, which is defined by the wire (1) straight line.

The cutter (34) of wire (3) is transferred to the appropriate position upon activation of piston (64).

Wires (2) and (3) are fed according to the step of the product and wire (1) is fed according to the length of the transversal wire.

Upon activation of the hydraulic piston (73) the restrainer (37a) is relocated and holds wire (1) on the forming tool (39a).

Wire (1) is cut upon activation of the cutter's hydraulic piston (34).

Upon activation of the hydraulic piston (73), the frame (41) moves the forming mechanism and forms the wire (35a) to the shape (35b).

The ends of the formed wire are welded with the longitudinal wire (3) by the welding devices (42) and (43), while at the same time the forming tool and the restrainer press and hold the formed wire.

The transversal wire frame, already formed during the previous operation step, is welded to the longitudinal wire (2) at the welding device (44) simultaneously with the action of the welding devices (42) and (43).

In the next step, the hydraulic piston (73) is activated reversely and the forming tool (38a) moves backwards.

The hydraulic piston (76) is activated reversely and the restrainer (37a) moves backwards.

The pistons (81a) and (81b) are activated and the beam-guide (36) moves upwards, moving the tools also upwards, so that the formed transversal wire (35b) is completely released.

The pistons moving the welding devices (42) and (43) are activated, so that the welding copper electrodes are withdrawn and the transversal wire is released.

Wires (2) and (3) are fed at one product step and at the same time the push the already formed part towards its storage unit.

Upon activation of piston (64) the cutter (34) moves to its second location.

Upon activation of piston (81b) only, the forming tools (39b), (38b) and the restrainer (37b) are transferred at the direction of the wire (1).

The forming and welding procedure is repeated as stated above for the production of the second transversal wire frame.

When the product is manufactured at the appropriate length, it is cut off by a guillotine type cutter (45), upon activation of the hydraulic piston (112).

The cut off product is delivered to the storage unit (46), where it is stacked.

The method is non-restrictive concerning the number of different transversal shapes. The required transversal tools are mounted on the presented machine at a similar way as described above, where the lever may be driven by a servomechanism of pneumatic, hydraulic or electro-mechanic type of action.

The cutter of the transversal wire to be formed may be driven by a servomechanism in order to cut the wire at any position it may be required.

The transfer of the forming tools to the forming location may be implemented either through parallel translation, at a direction perpendicular to the beam (36), or through the beam's (36) rotation, as described earlier.

The welding devices (42), (43) and (44) may be fixed in the case where the welding electrodes are wide enough to cover different points of contact between the formed transversal with the longitudinal wires, as in the implementation of the machine which was described earlier. For production of different shapes of transversal wire frames, the welding devices can be placed on transfer frames, which move the devices at the appropriate locations along the longitudinal wires, so that welding of the formed transversal wires with the longitudinal wires can take place.

The advantages of the present invention are the following:

The machine that is manufactured with the present method is extremely flexible, making any change of geometry of the produced part simple, by re-positioning the welding devices and the cutter at the proper location, and by alternating the forming tools.

Excellent quality of the final product, since welding with one of the two longitudinal wires is executed simultaneously with the formation of the transversal wire.

The machine is characterized by high production capacity, due to the simple movements, which are required, and the capability for simultaneous forming and welding.

The machine operation is simple and its construction is compact and robust.

The machine is distributed for easy attendance, access and operation.

The machine operation is fully automated and only the operator's attendance is required.

The materials and components used for the implementation of this invention, as well as their dimensions, can vary, in accordance with special requirements.

In every claim, where technical specifications are referred to there are corresponding explanatory numbers, which are only meant to increase the comprehension of the claims, and these numbers do not limit the descriptions at any way.

1. A method for production of continuous or non-continuous concrete reinforcement from wire or rod or tube or other material of prismatic cross section, where each of the three wires (1), (2), (3), is separately pulled through a drive mechanism from a pay-off station,
is straightened at a straightening device, (7), (8), (9) respectively, is fed to a storage unit (buffer) (13), (14), (15) respectively, it advances to the forming and welding mechanism, where the transversal frame is formed and welded in a continuous stepwise manner, where through the action of a cutter (45), the product is cut at the proper lengths, and advances towards a collection unit (46), where it is stacked, where the method is characterized by the parallel feeding of the three wires to the welding and forming mechanism, where the first wire (1),
is fed at a length equal to the length of the transversal wire frame (35a), and the other two wires (2) and (3) are fed at a length equal to the step of the product, where the first wire is guided at the forming moulds (37) and (39), and the cutter (34) being at the proper location in order to cut the wire (1) at a length (37a) which is equal to the length of the transversal wire (37b), where the other two wires (2), (3), are kept at a fixed distance between them, where the method is also characterized by three welding devices, namely the two devices (42) and (43), which are located at each side of the forming tool axis YY′, at points B and C respectively, where the transversal formed wire (35b) intersects with the second longitudinal wire (3), and a third welding device (44), which is placed on the first longitudinal wire (2) at a distance from the formation axis equal to an integer multiple of the product step, where the method is also characterized by a restrainer (37) holding the wire to be formed (35a) firmly on a fixed mould (39), where the wire is then cut by a cutter (34) and at the same time it is formed by the action of the moving mould (38) as it moves towards the fixed mould (39), until it gets the form of the transversal piece (35b), where the method is characterized by the welding of the formed wire (35b) with the longitudinal wire (3), at the formation location, while it is still being held by the restrainer (37), and by the simultaneous welding of one already prepared transversal piece with the first longitudinal wire (2) on the welding device (44), where the method is also characterized by the withdrawal of the moving mould (38) away from the steady mould (39), the consequent withdrawal of the restrainer (37), the relocation of the transversal wire forming subsystem at a direction normal to the plane of the product, the advancement of the longitudinal wires (2) and (3) at a distance equal to the product step, carrying along the already manufactured product, the advancement of the wire (1) at a distance equal to the length of the transversal wire, and so on until the production process is completed.

2. Method according to claim 1, where the transversal wire frames can be of different shapes, which are produced by different sets of moving forming moulds (38a), (38b) etc., fixed moulds (39a), (39b) etc. and restrainers (37a), (37b) etc., mounted on different planes per each set, and being parallel to the forming plane, where each set of moving mould, fixed mould and restrainer can move perpendicularly to the forming plane, so that the appropriate, each time, set of tools is transferred on the forming plane for the forming of each transversal wire.

3. Method according to claims 1, 2, where the transversal wire is welded with one of the two longitudinal wires at the formation location, while it is still held firmly by the restrainer and the forming mould.

4. Method according to claims 1, 2, where the transversal wire is welded with the second longitudinal wire without protruding beyond the second longitudinal wire.

5. Method according to claims 1, 2, 3, where the transversal wire is welded with the second longitudinal wire (2) at a distance equal to an integer multiple of the product step, while at the same time a formation and welding operation takes place at the formation location.

6. Method according to claims 1, 2, 3, where the location of the cutter (34) with respect to the formation axis YY′ varies, depending on the shape and the length of the transversal wire.

7. Machine for the production of continuous or non-continuous concrete reinforcement from wire, tube or other material of prismatic cross section, according to claims 1, 2, 3, where three wires (1), (2), (3) are uncoiled from their pay off stations each one separately, via rotating straightening devices (7), (8), (9) respectively, into storage units (wire buffers) (13), (14), (15) respectively, and where each wire is driven via pairs of straightening rollers (22) and (23), (24) and (25), (26) and (27) through a single-plane straightening device (31), (32), (33) respectively, towards the forming and welding mechanism, where the product is formed and welded at a continuous form, where the product is then fed through a cutter (45), where it is cut at the appropriate lengths, and then fed to a collection unit (46), where it is stacked, where the machine is characterized by the advancement of the wire (1) via a servomotor (28) and pairs of feeding rollers (22), (23), at a specific distance (35a) equal to the length of the transversal wire (35b), and by the advancement of the longitudinal wires (2) and (3) via the servomotors (29) and (30) and the pairs of the feeding rollers (24), (25) and (26), (27) at a distance equal to the product step, towards the welding mechanism, where at the welding mechanism, the wire (1) or (35a) is firmly held by the restrainer (37) on the tool (39), is cut by the cutter (34) and is simultaneously formed (35b) by the action of the forming tools (38), where the machine is also characterized by the action of the welding devices (42) and (43) exactly at the intersections of the already formed transversal wires (35b) and the longitudinal wire (3), where the transversal wire (35b) is welded to the longitudinal wire (3) while it is still restrained by the forming tools (38) and (39), and by the action of a third welding device (53), located at a distance from the formation axis YY′ equal to an integer multiple of the product step, where the already formed transversal wire is welded with the longitudinal wire (2), simultaneously with the forming of a new transversal wire in the forming location YY′, and where the machine is also characterized by the consequent withdrawal of the restraining and forming tools away from the formation plane, so that the already formed transversal wire (35b) is completely released, so that another machine operation cycle of the machine can be repeated.

8. Machine for the production of continuous or non-continuous concrete reinforcement from wire, tube or other material of prismatic cross section according to claims 1, 2, 3 and 7, where the formed transversal wires can be of various, alternating shapes, which are produced by different sets of restrainers (37a), (37b) etc., moving forming tools (38a), (38b) etc. and fixed forming tools (39a), (39b) etc., where the different sets of tools are mounted on different parallel planes, which are parallel to the formation plane, and which can move in a direction perpendicular to the formation plane, so that the appropriate, each time, set of tools is transferred to the formation plane for the forming of the transversal wire.

9. Machine for the production of continuous or non-continuous concrete reinforcement from wire, tube or other material of prismatic cross section, according to claims 1, 2, 3, 7 and 8, where the transversal wire formation mechanism as well as the restraining tools are mounted on a projected beam (34), which is simply supported at the far end through a joint (40) and can rotate about it upon the action of a piston (81), in order to bring to the formation plane the appropriate set of tools.

10. Machine for the production of continuous or non-continuous concrete reinforcement from wire, tube or other material of prismatic cross section, according to claims 1, 2, 3, and 7, where the forming tools are mounted on two metal blades (65), which can rotate about the pins (66) on the moving frame (36), and are pressed towards the fixed tool (39) by contracted disc-type springs (69).

11. Machine for the production of continuous or non-continuous concrete reinforcement from wire, tube or other material of prismatic cross section, according to claims 1, 2, 3 and 7, where a special mechanism can move the wire cutter (34) to the proper location, in order to cut the wire (35a) at the proper length, equal to the length of the development of the wire (35b).
